(19) United States
(12) Patent Application Publication
(10) Pub. No.: US 2025/0228160 A1
(43) Pub. Date: Jul. 17, 2025

(54) EXTRACTOR FOR A SUGARCANE HARVESTER

(71) Applicant: Deere & Company, Moline, IL (US)

(72) Inventors: Michael L. Halbrook, Thibodaux, LA (US); Jason C. Buss, Thibodaux, LA (US); John A. Dighton, Napoleonville, LA (US); Justin J. Morgan, Schriever, LA (US)

(21) Appl. No.: 18/409,879

(22) Filed: Jan. 11, 2024

(51) Int. Cl. A01D 45/10; A01D 43/08

(52) U.S. Cl. CPC A01D 45/10; A01D 43/085

(57) ABSTRACT

A sugarcane harvester includes an extractor system having a housing defining an interior passage leading to an exhaust outlet. A fan assembly is positioned within the interior passage for inducing a flow of air across a flow of sugarcane billets and through the interior passage for extracting leaf residue. A constituent sensor is positioned to detect data related to a sugar content of the extracted material, including the leaf residue, moving through the interior passage of the housing. A controller may determine a current sugar content of the extracted material passing through the interior passage of the housing from data sensed by the constituent sensor, and determine that the extracted material passing through the housing includes sugarcane billets when the current sugar content is greater than a trash sugar content threshold.

### TECHNICAL FIELD

The disclosure generally relates to a sugarcane harvester, and more particularly to an extractor for removing leaf residue from a flow of sugarcane billets.

### BACKGROUND

Sugarcane harvesters often have a chopper, an elevator, and one or more extractors. The chopper cuts sugarcane stalks harvested by the sugarcane harvester into segments called “billets.” The elevator lifts the billets to a higher elevation for discharge into a wagon for transport to a mill. A primary extractor is located between the chopper and the elevator. In sugarcane harvesters that have a secondary extractor, the secondary extractor is mounted to the upper discharge end of the elevator. Each extractor has a fan assembly to induce a flow of air to extract leaf residue from a flow of sugarcane billets so as to clean the billets. The material extracted by each extractor, i.e., the extracted material, e.g., the leaf residue, is then discharged from the sugarcane harvester.

On occasion, it is possible for a sugarcane billet to pass through the extractor system, thereby reducing the sugar harvest. In order to identify if/when sugarcane billets are passing through the extractor, the extractor may include an impact sensor positioned on a hood and/or deflector of a housing of the extractor. The impact sensor may register an impact event in response to a billet contacting the hood. A controller may notify an operator of the impact event, who may then modify operation of the harvester and/or track a harvest loss. However, the impact sensor may only detect impact events exhibiting an impact force greater than a threshold. If the billet does not include enough mass and/or rigidity sufficient to generate the minimum impact force, for example if the billet is small and/or shredded, then the resultant impact force may be less than the threshold and the impact sensor may fail to register an impact event.

### SUMMARY

A sugarcane harvester is provided. The sugarcane harvester may include an extractor system including a housing defining an interior passage having an exhaust outlet. The extractor system further includes a fan assembly positioned within the interior passage of the housing and configured for inducing a flow of air across a flow of sugarcane billets and through the interior passage for extracting leaf residue from the flow of sugarcane billets. The extractor system discharges the leaf residue through the exhaust outlet. A constituent sensor is positioned to detect data related to a sugar content of extracted material moving through the interior passage of the housing. The extracted material may include the leaf residue, juices and/or liquids released from cutting sugarcane stalks into billets, and possibly sugarcane billets.

In one aspect of the disclosure, the sugarcane harvester may include a controller. The controller may include a processor and a memory having a billet loss detection algorithm saved thereon. The processor is operable to execute the billet loss detection algorithm to determine a current sugar content of the extracted material passing through the interior passage of the housing from data sensed by the constituent sensor.

In one aspect of the disclosure, the processor may be operable to execute the billet loss detection algorithm to compare the current sugar content of the extracted material passing through the interior passage to a trash sugar content threshold to determine if the current sugar content of the extracted material passing through the interior passage is less than or equal to the trash sugar content threshold or if the current sugar content of the extracted material passing through the interior passage is greater than the trash sugar content threshold. The trash sugar content threshold may be defined to approximately equal a sugar content value associated with normal operating conditions in which no billets are passing through the interior passage of the housing. Sugar content levels equal to or below the trash sugar content threshold may then indicate normal operation in which no sugarcane billets are passing through the extractor system, whereas elevated sugar content levels above the trash sugar content threshold may indicated sugarcane billets are passing through the extractor system.

In one aspect of the disclosure, the processor may be operable to execute the billet loss detection algorithm to communicate a billet loss notification signal to a communicator when the current sugar content of the extracted material passing through the interior passage is greater than the trash sugar content threshold. the communicator may include, but is not limited to, a communication device located in an operator's station of the sugarcane harvester, for example, a warning light, a message on a visual display, a speaker or audio communicator, etc. In other implementations, the communicator may be located remotely from the sugarcane harvester, for example, a computing device of an associated fleet/harvest management system.

In one aspect of the disclosure, the processor may be operable to execute the billet loss detection algorithm to control a harvest system operating parameter when the current sugar content of the extracted material passing through the interior passage is greater than the trash sugar content threshold. The harvest system operating parameter may include an operational setting of the sugarcane harvester that affects billet size, billet quantity, billet transfer speed, leaf extraction, etc. For example, the harvest system operating parameter may include, but is not limited to, one of a chopper speed of a billet chopper system, a fan speed of the fan assembly of a primary extractor, a fan speed of the fan assembly of a secondary extractor, a speed of a feed section supplying sugarcane to the chopper system, a speed of an elevator, a ground speed of the sugarcane harvester, a position/angle of a billet deflector, a position, of the fan assembly within the housing of the extractor, a blade pitch of the fan of the fan assembly, an angular orientation of the fan assembly, operation of other additional trash cleaning systems and/or air moving systems, etc.

In one aspect of the disclosure, the processor may be operable to execute the billet loss detection algorithm to register a sugar loss sum in the memory. The sugar loss sum may be defined as the sum of the determined current sugar content of the extracted material passing through the interior passage measured over a period of time. For example, the controller may continuously determine the current sugar content of the extracted material passing through the interior passage over the period of time. The cumulative sugar content over that period of time may be the sugar loss sum. In other implementations, the controller may determine the current sugar content of the extracted material passing through the interior passive over the period of time at discrete time intervals. The determined sugar content at each discrete time interval may be summed to equal the sugar loss sum. The sugar loss sum may be expressed in terms of a total cumulative value, or with respect to some other variable, such as but not limited to, time, distance, or area. For example, the sugar loss sum may be expressed in terms of the cumulative sugar loss sum for a given time, the cumulative sugar loss sum per unit distance, or the cumulative sugar loss sum per unit area. An operator may then use the sugar loss sum to make future decisions regarding growing and harvest operations.

In one aspect of the disclosure, the constituent sensor may include, but is not limited to, a Near Infra Red (NIR) sensor. The NIR sensor may be positioned to capture an image of the extracted material passing through the interior passage of the housing. In one implementation, the housing may include a transparent window configured to enable the constituent sensor, e.g., the NIR sensor, to capture the image therethrough.

In one implementation of the disclosure, the constituent sensor may be positioned between the fan assembly and the exhaust outlet. In other implementations of the disclosure, the constituent sensor may be positioned upstream of the fan assembly relative to a flow path of the extracted material passing through the interior passage.

In one implementation, the housing may include a sampling bypass. The sampling bypass forms a passageway through which a sample portion of the extracted material may pass through for analysis by the constituent sensor. The sampling bypass includes a bypass entrance open to the interior passage of the housing for allowing the sample portion of the extracted material to pass through the sampling bypass. The constituent sensor may be positioned to detect the data related to the sugar content of the extracted material within the sampling bypass. The sample portion of the extracted material may include a continuous flow, or may include discrete sample portions extracted in individual portions from the interior passage of the housing.

In one aspect of the disclosure, the sampling bypass may include a sample conditioner positioned therein. The sample conditioner is configured for processing the sample of the extracted material in preparation for analysis by the constituent sensor. The sample conditioner may include a mechanical or chemical system and/or components operable to separate the constituents of the sample portion of the extracted material. For example, the sample conditioner may include a mechanical shredder operable to macerate the sample portion of the extracted material to improve operation and results of the constituent sensor.

In one aspect of the disclosure, the sugarcane harvester may further include a chopper configured for cutting sugarcane stalks into the billets, and an elevator configured for lifting the billets to an elevated position and discharging the billets into a wagon. In one implementation, the extractor system may be implemented as a primary extractor disposed between the chopper and the elevator. In another implementation, the extractor system may be implemented as a secondary extractor disposed proximate an upper end of the elevator.

Accordingly, the sugarcane harvester and the extractor system described herein detect sugarcane billet loss via the sugar content of the material passing through the interior passage of the housing. Sugar content levels of the extracted material passing through the extractor above the sugar content threshold may indicate sugarcane billets are also included in the extracted material. Accordingly, billets in the extracted material that may not generate enough impact force for detection by an impact sensor may be detected based on the elevated sugar content of the extracted material, thereby enabling sugar loss detection for billets that may be too small and/or too shredded for detection with an impact sensor.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a sugarcane harvester.

FIG. 2 is a schematic perspective cross-sectional view of an extractor system of the sugarcane harvester.

FIG. 3 is a schematic cross-sectional view of the extractor system.

FIG. 4 is a schematic cross-sectional view of an alternative embodiment of the extractor system.

FIG. 5 is a flow chart representing a billet loss detection process.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

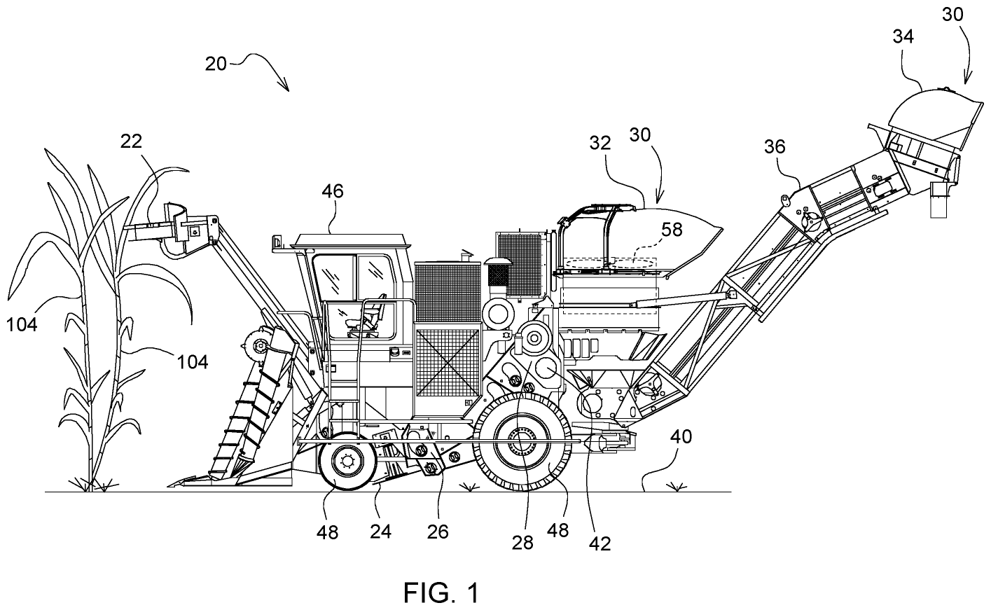

Referring to the Figures, wherein like numerals indicate like parts throughout the several views, a sugarcane harvester is generally shown at 20 in FIG. 1. Referring to FIG. 1, the sugarcane harvester 20 is configured to harvest sugarcane while traversing through a field. The example implementation of the sugarcane harvester 20 shown in the Figures and described herein includes, but is not limited to, a topper 22, a basecutter 24, a feed section 26, a chopper 28, an extractor system 30, e.g., a primary extractor 32 and/or a secondary extractor 34, and an elevator 36. It should be appreciated that the sugarcane harvester 20 may differ from the example implementation shown in the Figures and described herein.

The topper 22 cuts leaf material off the top of the sugarcane plants before the plants are severed by the basecutter 24. However, the topper 22 may not remove all the leaf material from the plants before ingestion into the sugarcane harvester 20. The leaf material remaining with the sugarcane stalks 104 that is ingested into the harvester may be referred to as leaf residue 38.

The basecutter 24 may include a left cutting disk and a right cutting disk. The left and right cutting disks of the basecutter 24 cooperate with one another to sever the stalks 104 of sugarcane plants at a location near a ground surface 40. The basecutter 24 feeds a mat of the severed sugarcane stalks 104 rearward to the feed section 26. The feed section 26 receives the mat of severed sugarcane stalks 104 from the basecutter 24 and moves the mat rearwardly to the chopper 28. The chopper 28 receives the mat of sugarcane stalks 104 from the feed section 26. The chopper 28 may include a drum 42 configured for cutting the stalks 104 of sugarcane into billets 44. As described in greater detail below, juices and/or liquids from the sugarcane stalk may be released from the stalk when the chopper 28 cuts the sugarcane stalk into the billets 44.

As noted above, the sugarcane harvester 20 includes an extractor system 30. The extractor system 30 includes the primary extractor 32, and may additionally include the secondary extractor 34. The primary extractor 32 is positioned between the chopper 28 and the elevator 36. As noted above, some leaf residue 38 may remain with the sugarcane stalks 104 as the stalks 104 are processed into billets 44. The primary extractor 32 extracts the leaf residue 38 discharged from the chopper 28 with the billets 44 as the billets 44 move between the chopper 28 and the elevator 36, and removes the leaf residue 38 from the sugarcane harvester 20. The leaf residue 38 removed by the extractor system 30 may be referred to as extracted material 62, and may further include the juices released by the stalks 104 when the chopper 28 cuts the sugarcane stalks 104 into the billets 44. The combination of the leaf residue 38 and the juices included in the extracted material 62 may be referred to herein as “trash”. The elevator 36 is positioned at the rear of the sugarcane harvester 20 to receive the billets 44 from the chopper 28 and convey them to an elevated position where the billets 44 are discharged from the sugarcane harvester 20 into a wagon to be hauled away. The secondary extractor 34 system 30 may be mounted to the upper discharge end of the elevator 36 to further extract leaf residue 38 from the billets 44 that may not have been removed by the primary extractor 32.

The sugarcane harvester 20 includes an operator's station 46 and traction elements 48. A human operator can operate the sugarcane harvester 20 from the operator's station 46. The traction elements 48 are positioned on the left and right sides of the sugarcane harvester 20 for engaging the ground surface 40 and propelling the sugarcane harvester 20 along the ground surface 40. Illustratively, there may be two traction elements 48, each in the form of a ground-engaging wheel, located on each side of the sugarcane harvester 20. In other embodiments, there may be one traction element 48, in the form of a track unit, located on each side of the sugarcane harvester 20.

The teachings of the disclosure related to the extractor system 30 are described using the primary extractor 32 as an example implementation. However, it should be appreciated that the secondary extractor 34 and the primary extractor 32 include the same general components and operate in the same general manner. As such, it should be appreciated that the teachings of this disclosure related to the extractor system 30 may apply to both the primary extractor 32 and the secondary extractor 34.

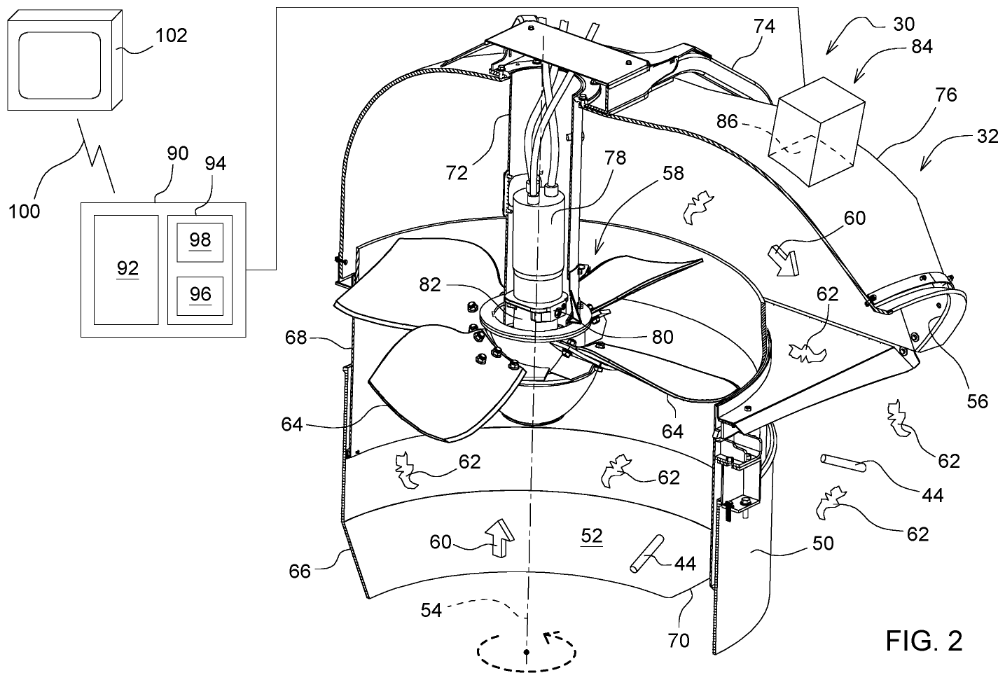

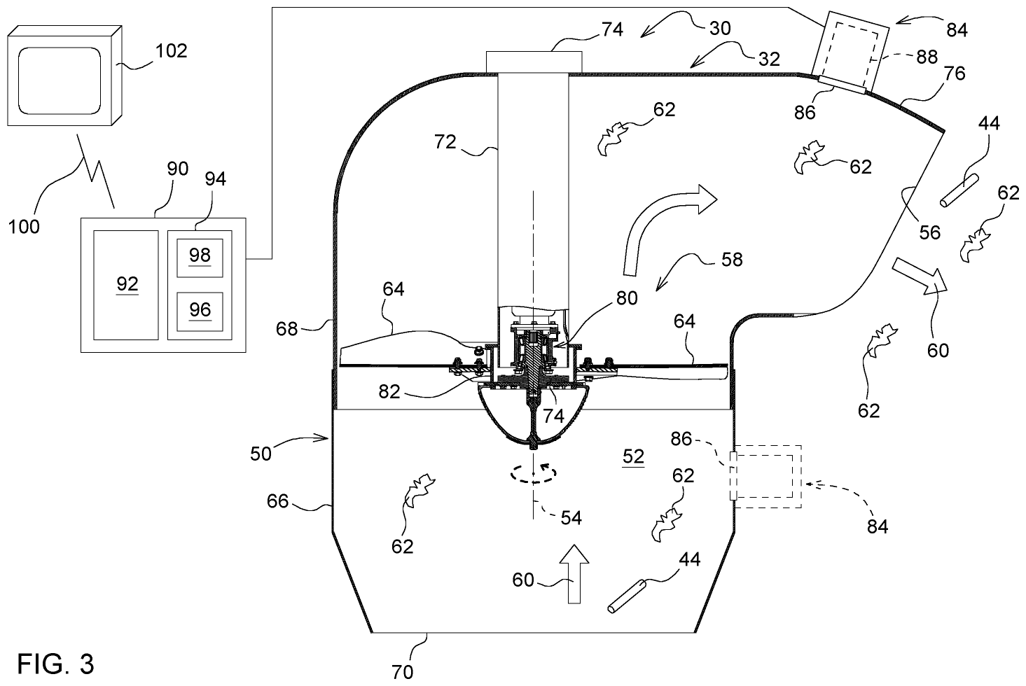

Referring to FIGS. 2 and 3, the extractor system 30, e.g., the primary extractor 32 and/or the secondary extractor 34, includes a housing 50 defining an interior passage 52 extending along a central axis 54. The housing 50 further defines an exhaust outlet 56 of the interior passage 52 for discharging the extracted material 62 from the sugarcane harvester 20. The extractor system 30 further includes a fan assembly 58 disposed and/or positioned within the interior passage 52 of the housing 50. The fan assembly 58 is configured for inducing a flow of air 60 across the flow of sugarcane billets 44 moving between the chopper 28 and the elevator 36. The induced flow of air 60 removes the leaf residue 38 from the flow of sugarcane billets 44, and moves the leaf residue 38, i.e., the extracted material 62, through the interior passage 52 of the housing 50 and discharges the extracted material 62 through the exhaust outlet 56 of the housing 50.

The fan assembly 58 includes one or more fan blades 64 (e.g., four fan blades 64) mounted for rotation about the central axis 54 in a direction of rotation of the fan blades 64. Rotation of the fan blades 64 about the central axis 54 induces the flow of air 60 through the interior passage 52 of the housing 50 of the fan assembly 58. The flow of air 60 through the fan assembly 58 extracts the leaf residue 38 from the flow of billets 44 produced by the chopper 28. The billets 44 are airborne when discharged from the chopper 28, facilitating separation of the leaf residue 38 from the billets 44 by the flow of air 60 induced by the fan assembly 58 of the primary extractor 32. Similarly, the billets 44 are airborne when discharged from the elevator 36 at the secondary extractor 34 facilitating separation of leaf residue 38 from the billets 44 by the flow of air 60 induced by the fan assembly 58 of the secondary extractor 34.

The housing 50 may include a lower portion 66 and an upper portion 68 supported on the lower portion 66. The lower portion 66 is fixed to a frame of the sugarcane harvester 20 and includes an inlet 70 into the housing 50 through which billets 44 and leaf residue 38 enter the extractor from the chopper 28. The fan assembly 58 is supported by the housing 50 for rotation relative to the housing 50 about the central axis 54. The upper portion 68 includes a support column 72. The support column 72 is positioned within the housing 50 and is coupled to and depends from a spider 74 of a frame of the upper portion 68. The upper portion 68 includes a hood 76 coupled thereto. The hood 76 may define the exhaust outlet 56. A rotator can rotate the hood 76 to direct discharge of extracted material 62 from the exhaust outlet 56 for discharging the extracted material 62 from the extractor system 30.

The extractor system 30, e.g., the primary extractor 32 and/or the secondary extractor 34, includes a motor 78 and a bearing assembly 80. The motor 78 and the bearing assembly 80 are positioned within and supported by the support column 72. The motor 78 includes an output that rotates about the central axis 54. The output includes a motor shaft and a coupling splined to the motor shaft and extending through the bearing assembly 80 downwardly out of the support column 72. The extractor includes a hub 82 coupled to the motor 78. The hub 82 is rotatably driven about the central axis 54. The motor 78 is drivingly coupled to the hub 82 via the output to rotate the hub 82 and the fan assembly 58 coupled thereto about the central axis 54. The hub 82 receives and is coupled to the output for rotation of the hub 82 therewith about the central axis 54.

The fan blades 64 are coupled to the hub 82 for rotation together with the hub 82 about the central axis 54. Such rotation of the fan blades 64 induces the flow of air 60 through the interior passage 52 of the housing 50. The fan blades 64 are coupled to the hub 82 thereabout via a set of attachment points on the hub 82. The fan blades 64 may be coupled respectively to the attachment points with fasteners (e.g., bolts).

The extractor system 30 removes material from the flow of sugarcane billets 44. As noted above, the material removed from the flow if sugarcane billets 44 by the extractor system 30 may be referred to herein as extracted material 62. The extracted material 62 may include, but is not limited to, the leaf residue 38, as well as the juices and/or liquids released by the chopper 28 when cutting the sugarcane stalks 104 into the sugarcane billets 44. Additionally, sugarcane billets 44 may be inadvertently removed with the leaf residue 38 and form a portion of the extracted material 62.

The extracted material 62, including the leaf residue 38 and the juices released from the sugarcane stalks 104 by the chopper 28, include sugar, i.e., have a sugar content. As such, the extracted material 62 removed by the extractor system 30 and passing through the interior passage 52 of the housing 50 will inherently exhibit a sugar content. A typical and/or acceptable sugar content for the extracted material 62 including the leaf residue 38 and juices, i.e., the trash, may be determined via testing, and may be considered a normal operating parameter of the sugarcane harvester 20 for a given quantity/volume/or yield of sugarcane billets 44. However, on occasion, sugarcane billets 44 may be inadvertently removed with the trash and also pass through the interior passage 52 of the housing 50, thereby becoming a portion of the extracted material 62. These billets 44 are discharged from the sugarcane harvester 20 with the trash. The billets 44 removed with the trash represent lost crop harvest. It should be appreciated that sugarcane billets 44 inherently exhibit a sugar content, and that the sugar content of the extracted material 62 passing through the interior passage 52 of the housing 50 of the extractor system 30 is increased above normal operating parameters when sugarcane billets 44 are present in the extracted material 62.

In order to detect sugarcane billets 44 that are removed by the extractor system 30 with the trash, i.e., the leaf residue 38 and juices, the extractor system 30, e.g., the primary extractor 32 and/or the secondary extractor 34, includes a constituent sensor 84. The constituent sensor 84 is positioned to detect data related to a sugar content of the extracted material 62 moving through the interior passage 52 of the housing 50.

In one implementation, the constituent sensor 84 may include, but is not limited to, a Near InfraRed (NIR) sensor. The NIR sensor 88 may include a device, e.g., a camera or other image capturing device, that is operable to detect and/or capture images in the near infra-red light spectrum. As is understood by those skilled in the art, the NIR sensor 88 uses light transmission and absorption to measure various constituents in a sample material such as: moisture, starch, protein, sugar, fat and oils. The manner in which NIR sensor 88s operate is understood by those skilled in the art, and is therefore not described in greater detail herein.

The NIR sensor 88 is positioned to capture an image of the extracted material 62 passing through the interior passage 52 of the housing 50. In one implementation, the housing 50 may include a transparent window configured to enable the constituent sensor 84 to capture the image therethrough. As such, the NIR sensor 88 may be positioned adjacent to but outside of the interior passage 52 of the housing 50, while still able to capture the image of the extracted material 62 moving through the housing 50.

While the example implementation of the disclosure includes the constituent sensor 84 implemented as the NIR sensor 88, it should be appreciated that the constituent sensor 84 may be implemented using a different type of sensor capable of detecting data related to the sugar content of the extracted material 62, and need not include the example implementation of the NIR sensor 88 described herein.

In one implementation, shown in solid lines in FIG. 3, the constituent sensor 84, e.g., the NIR sensor 88, may be positioned between the fan assembly 58 and the exhaust outlet 56 defined by the hood 76. When so positioned, it should be appreciated that the constituent sensor 84 is positioned downstream of the fan assembly 58 relative to a flow path of the extracted material 62 passing through the interior passage 52. In another implementation, shown in dashed lines in FIG. 3, the constituent sensor 84 may be positioned upstream of the fan assembly 58 relative to the flow path of the extracted material 62 passing through the interior passage 52. It should be appreciated that the position of the constituent sensor 84 may differ from the example locations shown in the Figures and described herein.

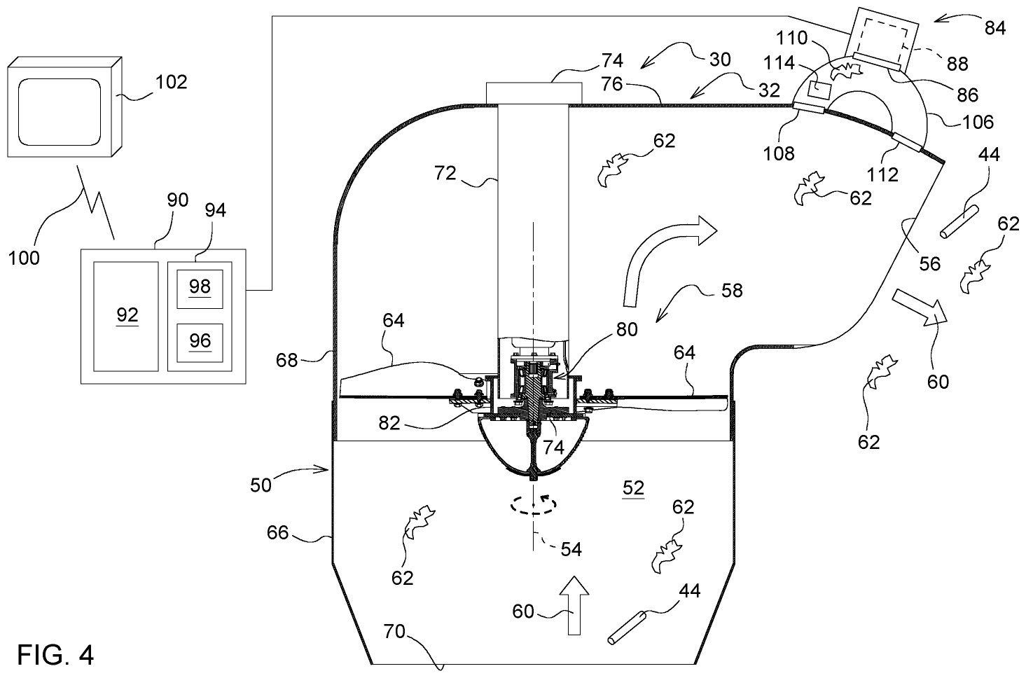

Referring to FIG. 4, an alternative implementation of the extractor system 30 is shown. In the implementation shown in FIG. 4, the housing 50 may include a sampling bypass 106. The sampling bypass 106 may form a separate passage through which a sample portion 110 of the extracted material 62 moving through the interior passage 52 of the housing 50 may pass for analysis/sensing by the constituent sensor 84. The sampling bypass 106 includes a bypass entrance 108 that is open to the interior passage 52 of the housing 50. The bypass entrance 108 allows the sample portion 110 of the extracted material 62 to pass through the sampling bypass 106. The constituent sensor 84 may be positioned to detect the data related to the sugar content of the extracted material 62 within the sampling bypass 106. For example, the constituent sensor 84 may be configured as an NIR sensor 88 positioned to capture images of the sample portion 110 of the extracted material 62 disposed within the sampling bypass 106.

The sample portion 110 of the extracted material 62 passing through the sample bypass may include a continuous flow, or may include discrete portions. When the sample portion 110 of the extracted material 62 includes a continuous flow, the constituent sensor 84 dynamically analyzes the sample portion 110 as the sample portion 110 of the extracted material 62 moves past the constituent sensor 84. Alternatively, when the sample portion 110 of the extracted material 62 is defined by discrete portions, the constituent sensor 84 may statically analyze the sample portion 110 without movement of the sampling portion relative to the constituent sensor 84. By doing so, accuracy of the constituent sensor 84 may be increased.

In one implementation, the sampling bypass 106 may include a bypass exit 112 that is open to the interior passage 52 of the housing 50. The bypass exit 112 allows the sample portion 110 of the extracted material 62 to return the interior passage 52. As such, the sampling bypass 106 includes a closed bypass passage that removes the sample of the extracted material 62 from the interior passage 52 of the housing 50 at the bypass entrance 108, and returns the sample of the extracted material 62 to the interior passage 52 of the housing 50 via the bypass exit 112. By so doing, the sampling bypass 106 may remain generally closed to exterior/ambient light intrusion, thereby improving the operating efficiency of the constituent sensor 84, particularly when configured as the NIR sensor 88. However, in other implementations, the sampling bypass 106 may exit directly to the exterior of the housing 50 such that the sample portion 110 of the extracted material 62 is discharged from the sugarcane harvester 20 via the sampling bypass 106 and is not returned to the interior passage 52 of the housing 50.

In one aspect of the disclosure, the extractor system 30 may include a sample conditioner 114 positioned within the sampling bypass 106. The sample conditioner 114 may be configured for processing the sample portion 110 of the extracted material 62 in preparation for analysis by the constituent sensor 84. For example, the sample conditioner 114 may include, but is not limited to, chopping, mulching, shredding, pulverizing or other mechanical and/or chemical processing components and/or systems to separate the constituents of the sample portion 110 and release the sugar from the sample portion 110 of the extracted material 62 prior to the constituent sensor 84 detecting the data related to the sugar content thereof.

The sugarcane harvester 20 may further include a controller 90. The controller 90 is disposed in communication with the constituent sensor 84 for receiving data therefrom. While the controller 90 is generally described herein as a singular device, it should be appreciated that the controller 90 may include multiple devices linked together to share and/or communicate information therebetween. Furthermore, it should be appreciated that the controller 90 may be located on the sugarcane harvester 20 or located remotely from the sugarcane harvester 20.

The controller 90 may alternatively be referred to as a harvester controller, a computing device, a computer, a control unit, a control module, a module, etc. The controller 90 includes a processor 92, a memory 94, and all software, hardware, algorithms, connections, sensors, etc., necessary to implement the process described herein. As such, a method may be embodied as a program or algorithm operable on the controller 90. It should be appreciated that the controller 90 may include any device capable of analyzing data from various sensors, comparing data, making decisions, and executing the required tasks.

As used herein, “controller 90” is intended to be used consistent with how the term is used by a person of skill in the art, and refers to a computing component with processing, memory, and communication capabilities, which is utilized to execute instructions (i.e., stored on the memory 94 or received via the communication capabilities) to control or communicate with one or more other components. In certain embodiments, the controller 90 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 90 may be in communication with other components on the sugarcane harvester 20, such as hydraulic components, electrical components, and operator inputs within the operator's station 46. The controller 90 may be electrically connected to these other components by a wiring harness such that messages, commands, and electrical power may be transmitted between the controller 90 and the other components. Although the controller 90 is referenced in the singular, in alternative embodiments the configuration and functionality described herein can be split across multiple devices using techniques known to a person of ordinary skill in the art.

The controller 90 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 94 may include any non-transitory/tangible medium which participates in providing data or computer-readable instructions. The memory 94 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The controller 90 includes the tangible, non-transitory memory 94 on which are recorded computer-executable instructions, including a billet loss detection algorithm 96. The processor 92 of the controller 90 is configured for executing the billet loss detection algorithm 96. The billet loss detection algorithm 96 implements a method of identifying and/or detecting billet removal through the extractor system 30, described in detail below.

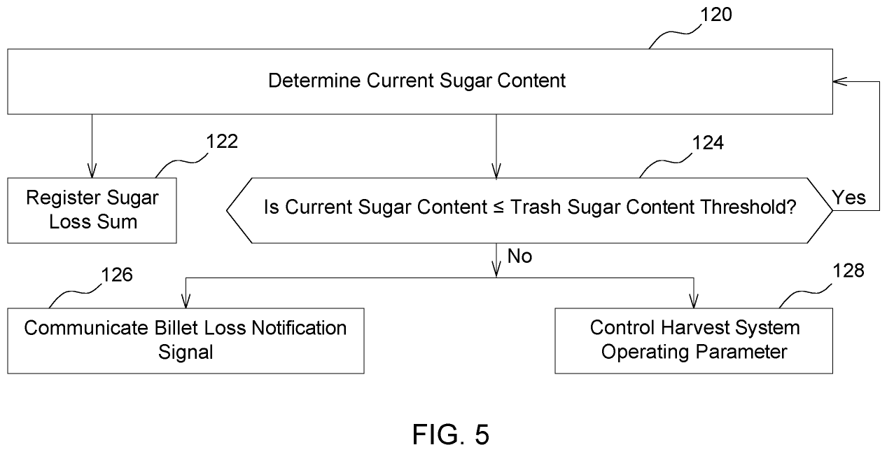

Referring to FIG. 5, the billet loss detection algorithm 96 determines a current sugar content of the extracted material 62 passing through the interior passage 52 of the housing 50 from data sensed by the constituent sensor 84. The step of determining the current sugar content of the extracted material 62 is generally indicated by box 120 shown in FIG. 5. The sugar content of the extracted material 62 may be expressed in terms of, but is not limited to, a weight or mass of sugar, or a percentage of sugar per mass or volume of extracted material 62.

As described above, the extracted material 62 may include, but is not limited to, the leaf residue 38, the juices and/or liquids suspended in the flow of sugarcane billets 44 that were released from the sugarcane stalks 104 when cut into the billets 44 by the chopper 28, and may additionally include incidental sugarcane billets 44. The controller 90 determines the current sugar content of all of the extracted material 62 present at that sampling. For example, if the extracted material 62 sampled at that time includes only the leaf residue 38 and suspended juices, then the determined sugar content of the extracted material 62 reflects the sugar content of the leaf residue 38 and suspended juices in that sample of the extracted material 62, i.e., the sugar content of the trash. However, if the extracted material 62 sampled at that time includes sugarcane billets 44 in with the leaf residue 38 and suspended juices, then the determined sugar content of the extracted material 62 reflects the sugar content of the sugarcane billets 44, leaf residue 38, and suspended juices in that sample of the extracted material 62.

The manner in which the controller 90 determines the sugar content of the extracted material 62 may depend upon the specific type of constituent sensor 84 utilized. For example, if the constituent sensor 84 is implemented as the NIR sensor 88 described herein, then the controller 90 may analyze the image captured by the NIR sensor 88 to identify the constituents of the extracted material 62, including but not limited to the sugar content of the extracted material 62. The manner in which the image from the NIR sensor 88 is analyzed to identify and/or determine the different constituents of the extracted material 62 is understood by those skilled in the art and is therefore not described in greater detail herein.

The controller 90 may register a sugar loss sum 98 in the memory 94 thereof. The step of registering the sugar loss sum 98 is generally indicated by box 122 shown in FIG. 5. The sugar loss sum 98 may be defined as the sum of the determined current sugar content of the extracted material 62 passing through the interior passage 52 measured over a period of time. The controller 90 may continuously determine the current sugar content of the extracted material 62 over the period of time, or may determine the current sugar content of the extracted material 62 at time intervals throughout the period of time. As such, multiple samplings of the extracted material 62 may be analyzed, with the controller 90 determining a current sugar content of the extracted material 62 at each sampling. The result of each sampling, i.e., the current sugar content of the extracted material 62 for each sampling, may be summed together to define the sugar loss sum 98 over the period of time. The sugar loss sum 98 may be expressed in terms of, but is not limited to, a total mass/weight of the sugar contained in the extracted material 62 over the period of time, a percentage of sugar per mass/volume of the extracted material 62 over the period of time. In other implementations, the sugar loss sum 98 may be expressed in terms of a total cumulative value, or with respect to some other variable, such as but not limited to, time, distance or area. For example, the sugar loss sum 98 may be expressed in terms of the cumulative sugar loss sum 98 for the period of time, the cumulative sugar loss sum per unit distance traveled by the sugarcane harvester 20, or the cumulative sugar loss sum 98 per unit area. The controller 90 may save the sugar loss sum 98 in the memory 94 for future reference by a user to aid in operations management and harvest analytics.

The controller 90 may further compare the current sugar content of the extracted material 62 passing through the interior passage 52 to a trash sugar content threshold. The step of comparing the current sugar content of the extracted material 62 to the trash sugar content threshold is generally indicated by box 124 shown in FIG. 5. The trash sugar content may be defined as the sugar content of the trash material extracted from the flow of sugarcane billets 44. As described above, the trash material includes the leaf residue 38 and the suspended juices, but does not include any billets 44 that may have inadvertently been extracted. As such, the trash sugar content may be defined as the sugar content of the extracted material 62 when no sugarcane billets 44 are present. The trash sugar content threshold may be defined to include a level or amount of sugar content in the extracted material 62 typical of proper operation of the extractor with no sugarcane billets 44 present in the extracted material 62. As such, sugar content values equal to or below the trash sugar content threshold indicate that no sugarcane billets 44 are present in the extracted material 62, whereas sugar content values greater than the trash sugar content threshold indicate that sugarcane billets 44 may be present in the extracted material 62.

The controller 90 may compare the current sugar content of the extracted material 62 passing through the interior passage 52 to the trash sugar content threshold to determine if the current sugar content of the extracted material 62 passing through the interior passage 52 is less than or equal to the trash sugar content threshold, or if the current sugar content of the leaf residue 38 passing through the interior passage 52 is greater than the trash sugar content threshold. When the current sugar content of the leaf residue 38 passing through the interior passage 52 is greater than the trash sugar content threshold, the controller 90 may communicate a billet loss notification signal 100 to a communicator 102. The step of communicating the billet loss notification signal 100 is generally indicated by box 126 shown in FIG. 5. The communicator 102 may include, but is not limited to, a device located in the operator's station 46 of the sugarcane harvester 20. For example, the communicator 102 may include a visual warning light, a visual display such as but not limited to a touch screen display, an audio warning device, etc. In other implementations, the communicator 102 may be located remote from the sugarcane harvester 20, and may include a computing device, such as a fleet management system or a harvest monitoring system.

In one aspect of the disclosure, the controller 90 may be configured to control a harvest system operating parameter of the sugarcane harvester 20. The step of controlling the harvest system operating parameter is generally indicated by box 128 shown in FIG. 5. In order to improve crop harvest and prevent billet loss through the extraction system, the controller 90 may control or adjust the harvest system operating parameter when the current sugar content of the leaf residue 38 passing through the interior passage 52 is greater than the trash sugar content threshold, thereby indicating that one or more sugarcane billets 44 has passed through the extractor system 30. The harvest system operating parameter may include, but is not limited to, one of a speed of the chopper 28 system, a speed of the fan assembly 58 of the primary extractor 32, a speed of the fan assembly 58 of the secondary extractor 34, a speed of the feed section 26 supplying sugarcane to the chopper 28, a speed of the elevator 36, a ground speed of the sugarcane harvester 20, a position/angle of a billet deflector, a position of the fan assembly 58 within the housing 50 of the primary extractor 32 and/or the secondary extractor 34, a blade pitch of the fan blades 64 of the fan assembly 58, an angular orientation of the fan assembly 58 relative to the housing 50, etc.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A sugarcane harvester comprising:
an extractor including a housing defining an interior passage having an exhaust outlet, the extractor further including a fan assembly positioned within the interior passage of the housing and configured for inducing a flow of air across a flow of sugarcane billets and through the interior passage for extracting leaf residue from the flow of sugarcane billets and discharging the leaf residue through the exhaust outlet; and
a constituent sensor positioned to detect data related to a sugar content of extracted material passing through the interior passage of the housing.

2. The sugarcane harvester set forth in claim 1, further comprising a controller including a processor and a memory having a billet loss detection algorithm saved thereon, wherein the processor is operable to execute the billet loss detection algorithm to determine a current sugar content of the extracted material passing through the interior passage of the housing from data sensed by the constituent sensor.

3. The sugarcane harvester set forth in clam 2, wherein the processor is operable to execute the billet loss detection algorithm to compare the current sugar content of the extracted material passing through the interior passage to a trash sugar content threshold to determine if the current sugar content of the extracted material passing through the interior passage is less than or equal to the trash sugar content threshold or if the current sugar content of the extracted material passing through the interior passage is greater than the trash sugar content threshold.

4. The sugarcane harvester set forth in claim 3, wherein the processor is operable to execute the billet loss detection algorithm to communicate a billet loss notification signal to a communicator when the current sugar content of the extracted material passing through the interior passage is greater than the trash sugar content threshold.

5. The sugarcane harvester set forth in claim 3, wherein the processor is operable to execute the billet loss detection algorithm to control a harvest system operating parameter when the current sugar content of the extracted material passing through the interior passage is greater than the trash sugar content threshold.

6. The sugarcane harvester set forth in claim 5, wherein the harvest system operating parameter includes one of a chopper speed of a billet chopper system, a fan speed of the fan assembly, a speed of a feed section, a speed of an elevator, a ground speed of the sugarcane harvester, a position or angle of a billet deflector, a position of the fan assembly within the housing of the extractor, a blade pitch of a fan blade of the fan assembly, or an angular orientation of the fan assembly relative to the housing.

7. The sugarcane harvester set forth in claim 2, wherein the processor is operable to execute the billet loss detection algorithm to register a sugar loss sum in the memory, wherein the sugar loss sum is the sum of the determined current sugar content of the extracted material passing through the interior passage measured over a period of time.

8. The sugarcane harvester set forth in claim 1, wherein the constituent sensor includes a Near Infra Red (NIR) sensor positioned to capture an image of the extracted.

9. The sugarcane harvester set forth in claim 8, wherein the housing includes a transparent window configured to enable the constituent sensor to capture the image therethrough.

10. The sugarcane harvester set forth in claim 1, wherein the constituent sensor is positioned between the fan assembly and the exhaust outlet.

11. The sugarcane harvester set forth in claim 1, wherein the constituent sensor is positioned upstream of the fan assembly relative to a flow path of the extracted material passing through the interior passage.

12. The sugarcane harvester set forth in claim 1, wherein the housing includes a sampling bypass having a bypass entrance open to the interior passage of the housing for allowing a sample of the extracted material to pass through the sampling bypass, with the constituent sensor positioned to detect the data related to the sugar content of the extracted material within the sampling bypass.

13. The sugarcane harvester set forth in claim 12, further comprising a sample conditioner positioned within the sampling bypass, wherein the sample conditioner is configured for processing the sample of the extracted material in preparation for the constituent sensor.

14. The sugarcane harvester set forth in claim 1, further comprising:
a chopper configured for cutting sugarcane stalks into the billets;
an elevator configured for lifting the billets to an elevated position and discharging the billets into a wagon; and
wherein the extractor is a primary extractor disposed between the chopper and the elevator.

15. An extractor system for a sugarcane harvester, the extractor system comprising:
a housing defining an interior passage having an exhaust outlet;
a fan assembly positioned within the interior passage of the housing and configured for inducing a flow of air across a flow of sugarcane billets and through the interior passage for extracting leaf residue from the flow of sugarcane billets and discharging the leaf residue through the exhaust outlet;
a constituent sensor positioned to detect data related to a sugar content of the extracted material moving through the interior passage of the housing; and
a controller including a processor and a memory having a billet loss detection algorithm saved thereon, wherein the processor is operable to execute the billet loss detection algorithm to determine a current sugar content of the extracted material passing through the interior passage of the housing from data sensed by the constituent sensor.

16. The extractor system set forth in claim 15, wherein the processor is operable to execute the billet loss detection algorithm to compare the current sugar content of the extracted material passing through the interior passage to a trash sugar content threshold to determine if the current sugar content of the extracted material passing through the interior passage is less than or equal to the trash sugar content threshold or if the current sugar content of the extracted material passing through the interior passage is greater than the trash sugar content threshold.

17. The extractor system set forth in claim 16, wherein the processor is operable to execute the billet loss detection algorithm to communicate a billet loss notification signal to a communicator when the current sugar content of the extracted material passing through the interior passage is greater than the trash sugar content threshold.

18. The extractor system set forth in claim 15, wherein the processor is operable to execute the billet loss detection algorithm to register a sugar loss sum in the memory, wherein the sugar loss sum is the sum of the determined current sugar content of the extracted material passing through the interior passage measured over a period of time.

19. The extractor system set forth in claim 15, wherein the constituent sensor includes a Near Infra Red (NIR) sensor positioned to capture an image of the extracted material passing through the interior passage of the housing.

20. The extractor system set forth in claim 15, wherein the housing includes a sampling bypass having a bypass entrance open to the interior passage of the housing for allowing a sample of the extracted material to pass through the sampling bypass, with the constituent sensor positioned to detect the data related to the sugar content of the extracted material within the sampling bypass.
